(19) United States
(12) Patent Application Publication
(10) Pub. No.: US 2010/0119785 A1
(43) Pub. Date: May 13, 2010

(54) FILM FORMATION AND EVALUATION

(75) Inventors: Lois Hobson, Teeside (GB); John Caroll, Stockton on Tees (GB); Qi Zong, Shanghai (CN)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: IMPERIAL CHEMICAL INDUSTRIES PLC, London (GB)

(21) Appl. No.: 12/310,862

(22) PCT Filed: Sep. 18, 2007
(86) PCT No.: PCT/GB2007/050557

§ 371 Date: Dec. 14, 2009

(30) Foreign Application Priority Data
Sep. 18, 2006 (GB) 0618293.5
Sep. 18, 2006 (GB) 0714428.0

(51) Int. Cl. B32B 3/10; B29C 47/02; B29C 47/12; B29C 45/58; B05C 5/02

(52) U.S. Cl. 428/195.1; 264/171.13; 425/461; 425/449

(57) ABSTRACT

Methods and apparatus for forming films from liquid samples for evaluation are disclosed. The liquid samples are dispensed into a channel formed by a die and a substrate on which the films are generated whilst moving the die and the substrate relatively to one another. Once formed, the liquid films may then be further processed, for example by curing or polymerization, to generate solid films for subsequent evaluation.

This invention relates to the formation of films on the surfaces of substrates and to the evaluation of characteristics of such films.

Coatings are widely used in both industrial and domestic environments to enhance the functionality and add-on value of bulk materials and articles and to enhance the appearance of structures. Other applications include non-continuous coatings such as inks. Organic coatings are particularly widely used in many industrial protective/decorative applications, such as automobile top clear coatings, automotive and decorative paints and lacquers, pigmented and unpigmented coatings, eg primer-, under- and top-coat paint systems, etc, and in inks. Other types of organic coatings include, for example, protective and anticorrosive coatings, adhesive and release coatings, environmental barrier coatings, electric conductive/optic transparent coatings and scratch resistant hard coatings. Although such coatings may consist solely of organic components, other coatings may contain inorganic elements such as metal oxide pigments, conductive metal particles, inorganic particle fillers, clays such as vermiculite and similar well known inorganic particles.

There are also many forms of inorganic coatings which may contain organic binders or alternatively may be formed from aqueous dispersions. Other forms of inorganic coatings may be formed by the direct application of the coating materials to substrates using techniques such as sputtering and chemical or physical vapour deposition.

In food and other applications, it may also be useful to form foodstuffs or other materials into films for testing or comparative purposes. Such foodstuffs and other materials that may be tested or compared are, for example, dough, starch films, sauces, mustards and the like and, in personnel care applications, toothpastes, shaving gels and the like.

The ability to test new combinations of ingredients for coating materials or new processing conditions, especially rapidly and in large numbers of samples, to discover next generation materials or new, cost-effective manufacturing methods is high on the agenda of many manufacturers to enable them to obtain commercial advantages over competitors. Also of significant importance is the ability to test existing formulations for performance drift, especially when substituting alternative ingredients or alternatively-sourced ingredients.

Such aspirations also apply more generally to other materials such as structural materials, particularly when at least some of the properties of interest of such materials may be determined from film samples of such materials.

Additionally, the generation of materials having multiple layers either for testing or for manufacture is of interest. Examples of such multilayer materials include the use of multiple layers of different adhesives for example to generate adhesion between substrates having different surface energies and, hence, different adhesion properties; primer, under and top coat paint systems; and multilayer semiconductor devices wherein the overall properties of such devices are highly dependent on not only the intrinsic properties of the constituent materials in each of the layers but also the particular layer stacking sequence, the interface and surface structures used in making such devices.

There have been attempts to generate and test samples of materials in high numbers, for example as disclosed in U.S. Pat. No. 6,482,264 B1, US 2003/0224105 A1, US 2004/0071888 A1 and DE 10136448 A1. These publications disclose a variety of methods of depositing and spreading samples on substrates to form films, including in some, spreading the liquid samples using non-contact methods, for example spinning or oscillating the substrate or using an air knife to spread the liquid samples or spraying the liquid samples onto the substrate. The deposition of adhesives to backing tapes in making self-adhesive tapes and sheets is also known and is described in GB 916406.

Such methods suffer from the disadvantage that, owing to the small amounts of liquid deposited on the substrates, the uniformity of the films formed may vary significantly and, consequently, the measured parameters may not be accurately determined. Whilst this may not be significant for some materials or for screening materials, for example on a pass/fail basis, it may, however, in other applications be more critical. For example, in determining colour specifications for paints, lacquers, inks etc, the thickness and uniformity of the film may significantly affect the colour determination process. Additionally, the amount of shear the sample is subjected to during spreading may affect the dispersion of pigment particles and, therefore, the uniformity of the resultant colour of the film sample.

Other techniques for forming films for testing, especially for forming films capable of being subjected to electrical resistivity measurements or for use in mechanical testing such as dynamic mechanical thermal analysis (DMTA), are known. Such techniques consist of forming a channel of a specified width and depth on a substrate, for example, a glass microscope slide or a substrate from which the film is easily released, by applying adhesive tapes of known thickness parallel to each other at a selected separation on the substrate, depositing a liquid sample in the channel and drawing a doctor blade across the upper surfaces of the tapes to remove excess liquid from the channel formed on the substrate. However, these techniques are time consuming, especially if multiple samples of the same or similar compositions are required or samples having multiple layers of materials are to be made.

It is an object of the present invention to reduce or obviate at least one of the aforementioned disadvantages.

According to a first aspect of the present invention, a method of forming a film on a surface of a substrate comprises providing a reservoir containing a liquid sample to be formed into a film at a sample location position on the substrate surface, said reservoir having an outlet comprising a die having a planar face which is contactable with said substrate to define therewith a channel for receiving at least a portion of said liquid sample from said reservoir, contacting said die with said substrate at one end of said sample location position, causing said liquid sample to extrude through said die and into said channel whilst substantially simultaneously moving said die and said substrate in contact with and relative to one another whereby said die moves towards a remote end of said sample location position to deposit a film of said liquid sample at said sample location position.

Although within the overall scope of the present invention, the reservoir may be any suitable shape provided that pressure may be applied to a liquid sample in it; in a preferred embodiment the reservoir is of a general cylindrical shape in which a piston is movable. In a particularly preferred embodiment, the reservoir is a commercially-available cartridge, such as plastic syringes available from EFD. Typically, the cartridge or syringe may have a volume in the range 5 ml to 100 ml, more preferably 5 ml to 50 ml and typically has a volume of 10 ml.

Preferably, the syringe is sealed at its outlet with a cap which is removable to permit fitting of said die thereto. Preferably, said die has an annular projection on the side opposite said planar face which is a push fit on to the outlet portion of the syringe in place of the cap. The annular projection defines part of a passage through said die through which a liquid sample may be extruded from the reservoir.

In the method of the invention, said liquid sample may flow through the die under capillary action of said liquid sample in contact with said substrate at said sample location position. Alternatively, or possibly in combination with capillary action, said liquid sample may flow through the die by having pressure applied to it.

Preferably, the method includes applying pressure to said liquid sample in the reservoir to cause said liquid sample to flow sufficiently to fill a prime volume in said die.

In a preferred embodiment of the present invention, said method comprises forming said channel by providing in the planar face of said die a rebate into which said passage opens.

In one embodiment, said rebate may extend longitudinally completely across the planar face of said die to opposed ends of said die to form openings thereat.

In an alternative embodiment, said rebate preferably extends only partially longitudinally across the planar face of said die at least from said passage to one end of said die to form an opening thereat. In this instance, said method comprises moving said die and said substrate relative to one another such that the end of the die in which said opening is located trails the direction of relative movement of said die. Preferably, said rebate extends a short distance past said passage towards the opposed end of said die whereby a dead space is formed.

In yet another alternative embodiment, said method comprises forming said channel by providing in said substrate at said sample location a groove whereby, when said die is contacted with said substrate at said one end of said sample location position, said channel is formed. Preferably, said groove is of predetermined length.

In yet a further alternative embodiment, said method comprises forming said channel by providing a rebate as previously described in the planar face of said die and a groove as previously described in said substrate at said sample location whereby, when said die is contacted with said substrate at said one end of said sample location position, said rebate and said groove together form said channel.

In the afore-described embodiments, preferably the rebate and/or the groove are of predetermined cross-section.

In preferred embodiments of the invention, the planar face of said die is flat. However, it is envisaged that it is within the scope of the invention to form films that are curved along their lengths, in which instance the substrate and the planar face of said die may be arcuate and complementary to one another in the direction of relative movement thereof.

Once the film has been deposited by said relative movement of the die and the substrate, the application of pressure to said liquid sample in the reservoir is ceased and the die is removed from the substrate.

As will be appreciated, when the method of the present invention utilises a die having a rebate, the method relies on the dynamic viscosity of the liquid sample deposited to maintain the film shape or cross-section. Consequently, when utilising such a die, the liquid will require a dynamic viscosity such that it maintains the film shape or cross-section. Typically, films have been formed using liquid samples having a dynamic viscosity in the range of about 0.05 Pa·s up to about 100 Pa·s.

However, the surface energy of the substrate surrounding the sample location position may be adjusted to permit the formation of films using liquid samples having a dynamic viscosity lower than about 0.05 Pa·s.

Additionally, when the method of the present invention utilises a substrate in which a groove is formed, it may also possible to form films from liquid samples having a lower dynamic viscosity, for example liquid samples having a dynamic viscosity of below about 0.05 Pa·s.

If arcuate films are to be formed, then clearly the dynamic viscosity of the liquid sample would have to be relatively high to enable it to retain its shape after deposition.

The force used to contact the die with the substrate is typically in the range from about 10N to about 100N, more typically about 15N to about 35N.

The force used to extrude the liquid sample from the reservoir will depend upon the dynamic viscosity of the liquid sample, a higher viscosity requiring a higher force. Typically, however, the force applied is in the range from about 0N to about 200N, depending on whether capillary action alone is relied upon or whether a positive force is applied. More preferably, the force applied is in the range from about 0.1 N to about 200N.

For many applications, it is preferred that the method of the invention comprises treating the film of liquid sample so formed to solidify it. This may involve no more than permitting solvent and/or carrier fluid to evaporate at ambient temperature. It may, however, include subjecting the liquid film to lyophilisation and/or heating and/or a reduced pressure environment to aid removal of the solvent and/or carrier fluid. Depending upon the chemical system under consideration in the film, the liquid sample may be cured and/or polymerised either at ambient temperature and/or pressure or below or above ambient temperature and/or pressure and/or using incident radiation, for example such as UV radiation, or by any other technique as is well understood in the art.

The method of the invention includes forming a film which comprises a composite film having at least two film layers, said composite film being formed by depositing a first film layer on the substrate by any of the embodiments herein before described and then depositing a second film layer onto the first film layer and, if desired, subsequent film layers in sequence on the second film layer and subsequent film layers. Depending on the embodiment used to deposit the first film layer on the substrate, ie whether the channel is defined by a groove and die without a rebate or a die having a rebate whether or not extending longitudinally of the planar face of the die or a combination thereof, a second film layer may be deposited on the first film layer using a die having a rebate which may or may not extend completely longitudinally of the planar face of the die. Subsequent film layers may be deposited on top of the uppermost film layer using a die having a rebate which extends completely longitudinally of the planar face of the die. At least one die having a rebate which extends completely longitudinally of the planar face of the die may be used to form at least one uppermost film layer, the depth of the rebate being greater than the thickness of the deposited film layer(s) protruding above the surface of the substrate.

To enable the first and subsequent film layers to withstand the deposition of a second and subsequent film layers thereon, the film layer receiving the further film layer has to be sufficiently stable to retain its shape during the deposition process. Such stability may at least in part be imparted by the die supporting the film layer during the deposition process. Alternatively, or additionally, the film layer receiving the further deposition of liquid sample may have a dynamic viscosity sufficiently high to retain its shape during the deposition of a further film layer or may be solidified as described above. The dynamic viscosity of the film layer receiving the further deposition of liquid sample may be inherently high or may be increased to a sufficient level by using the techniques described above to solidify the film.

The method of the invention includes forming a plurality of films on the substrate surface by depositing films at respective sample location positions on said surface that are in space relationship from one another. Conveniently, the number of samples dispensed on said surface is not more than 100, but typically may be 2 or more, for example 4, 8, 16, 32 or 64.

Preferably, the films formed on the substrate surface are discrete from one another.

Typically, the or each film formed has a width in the range of about 1 mm to about 150 mm, a length in the range about 5 mm to about 50 mm and a depth in the range 20 μm to 1000 μm, more typically 25 μm to 800 μm. It will be appreciated, however, that film size may be application dependent and may by higher or lower that the ranges quoted.

Although an array of films may on the surface of a single substrate, in alternative embodiments, single or multiple films may be formed on the surfaces of an array of substrates. For example, the substrate may be a microscope glass slide and have deposited thereon a single film. Alternatively, the substrate may have significant area and have deposited thereon more than one film. The material of the substrate may be any convenient material and typically may be glass, metal, plastics. The material of the substrate may have release qualities, for example a substrate of PTFE, whereby films capable of being free standing may be removed from the substrate for subsequent testing.

Once the film is formed, at least one characteristic of the film is determined. Without being limited to the following examples, the characteristic may be physical, eg colour, transparency, scratch resistance, wear; chemical, eg environmental stability/resistance; mechanical, eg strength, modulus; or electrical, eg resistance; conductivity.

In a particularly preferred embodiment of the invention, a method of forming a plurality of films at respective sample location positions on a surface of a substrate comprises:
(a) providing a plurality of liquid samples in respective syringes, which syringes being closed at their outlet ends by respective caps;
(b) either in parallel or preferably sequentially removing the cap from each syringe and fitting a die to the outlet end of the syringe, each said die being contactable with said substrate to define therewith a respective channel for receiving at least a portion of a liquid sample;
(c) either in parallel or preferably sequentially contacting said respective die with said substrate at one end of a respective said sample location position;
(d) either in parallel or preferably sequentially causing the liquid sample in each respective syringe to extrude through said respective die and into said respective channel whilst simultaneously moving said die and said substrate in contact with and relative to one another whereby said die moves towards a remote end of said sample location position to deposit a film of said liquid sample at said sample location position.

The features of the invention described previously apply mutatis mutandis to this particularly preferred embodiment of the invention as the context permits.

Preferably, the methods of the invention include the step of removing the die from the syringe and re-capping the syringe.

The invention also includes apparatus by which the methods of the invention may be performed.

More particularly, according to a second aspect of the invention, apparatus for forming a film on a surface of a substrate comprises a substrate support means and a dispensing system for dispensing at least one liquid sample at a sample locatio position on a surface of a substrate supported by said substrate support means during operation of said apparatus, said dispensing system comprising gripper means for holding a reservoir which, in use, contains a liquid sample, said reservoir having an outlet comprising a die having a planar face which is contactable with said substrate to define therewith a channel for receiving at least a portion of said liquid sample from said reservoir, said dispensing system being operable to contact said die with said substrate at one end of said sample location position whilst substantially simultaneously being operable to move said die and said substrate in contact with and relative to one another whereby said die moves towards a remote end of said sample location position to deposit a film of said liquid sample at said sample location position.

Apparatus features described previously in connection with the methods of the invention apply mutatis mutandis to apparatus according to the invention as the context permits.

Preferably, said dispensing system comprises means to apply pressure to a liquid sample in said reservoir.

Preferably, the dispensing system comprises a piston rod engageable with a piston in said reservoir whereby said piston is movable to effect positive displacement or drawback of said liquid sample in said reservoir. Preferably, said piston rod is movable relative to said gripper means by motive means preferably comprising a lead screw driven by, for example, a stepper motor, which is connected to said piston rod. Preferably, the motor is an MDrive stepper motor, available from IMS, USA, which provides a linear resolution of 1 μm.

Preferably, said piston rod is engageable with said piston by second gripper means. The second gripper means preferably comprises at least one, more preferably two, grippers movable between an inactive position and an active position in which the or each gripper engages said piston. Preferably, the or each gripper comprises spring steel and has radially-outwardly facing barbs that engage with said piston.

Preferably, said piston rod is hollow and has a diametral slot extending from its lower end over a part of its length, the or each gripper being mounted adjacent said lower end and being movable radially outwardly to said active position by radially-outward movement of opposed halves of said lower end of the piston rod against its natural resilience and being returned to said inactive position by radially-inward movement of the opposed halves of the piston rod under the natural resilience thereof. Radial movement of opposed halves of said piston rod is preferably achieved by axial displacement of a central member having an enlarged end and being mounted in said piston rod for movement relative thereto, for example using a pneumatic actuator.

The apparatus of the invention includes automated handling equipment for indexing said substrate support and said dispensing system relative to one another whereby, in use, at least two films may be deposited on a substrate surface at sample location positions on said surface that are in space relationship from one another.

The method and the apparatus of the invention also include such features as may be described below in connection with the accompanying drawings.

The invention also includes a die as herein described. The die may be made of any convenient material. For example, the die may be made of plastic material or metal. In either instance, depending upon the nature of the liquid samples and the materials of the dies, the dies may be either disposed of or, preferably, cleaned using solvents or other cleaning methods for subsequent re-use.

Preferably, the passage through the die terminates in a slot extending generally transversely of the die. Preferably, the slot extends substantially across the whole width of said channel definable between said die and a corresponding substrate with which said die is to be used.

As discussed earlier, coatings may be made of a wide variety of materials and, within the context of the present invention, films may be made from both organic and inorganic materials provided the materials are in liquid form, or in solution or dispersed in a liquid carrier. Typical applications include adhesives, polymers, resins, paints, inks, metal solutions, starches, dispersions, including nanoparticle dispersions, multi-layer semiconductor materials etc. In many such applications, the materials may be either conductive or non-conductive.

The present invention also includes at least one array of films, more preferably a library of films comprising at least two arrays of films each on a substrate, wherein each film is uniformly located with reference to a sample location position in the array.

The invention will now be illustrated by reference to the accompanying drawings and following examples. In the drawings:

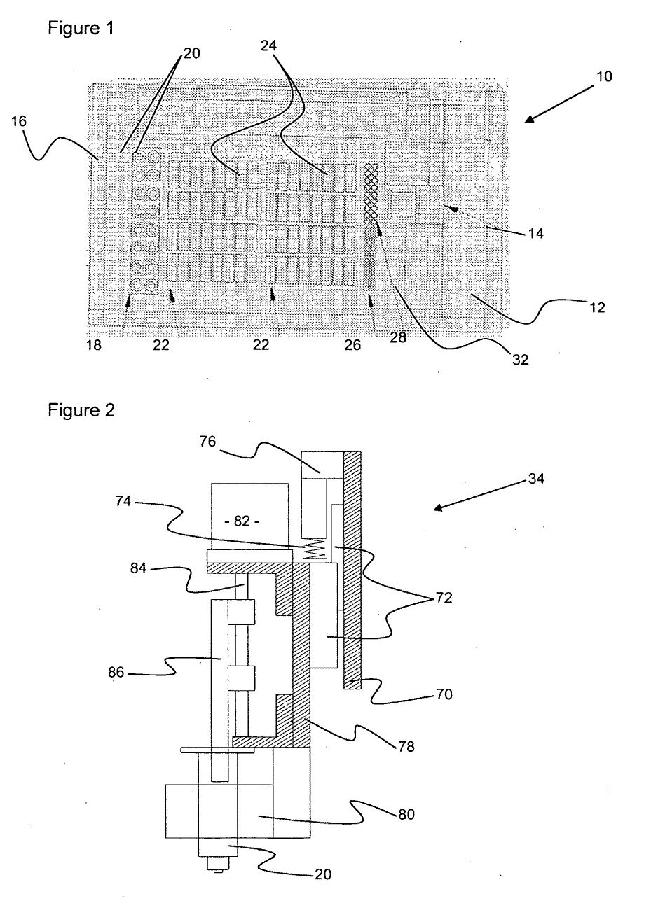

FIG. 1 is a schematic plan view of apparatus in accordance with the invention;

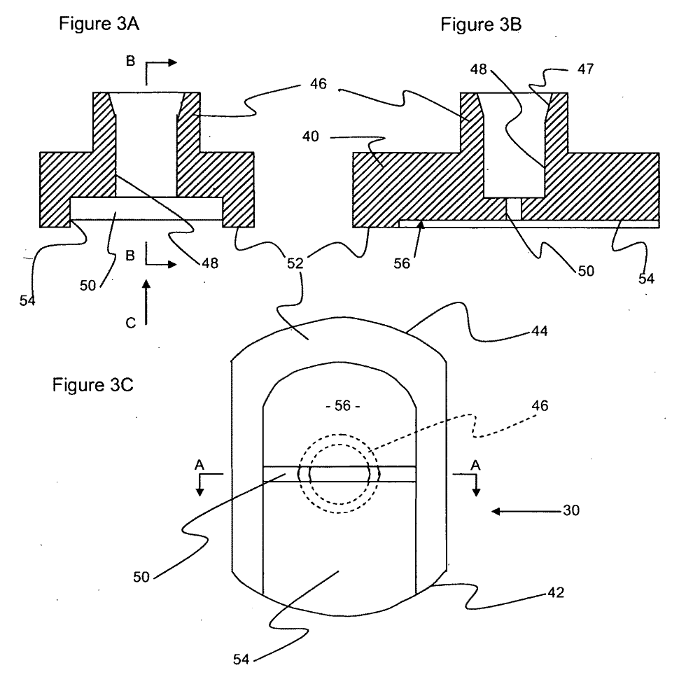

FIG. 2 is a schematic side view in partial section of a dispensing system of the apparatus shown in FIG. 1;

FIGS. 3A to 3C are respectively a cross-section on line A-A in FIG. 3C, a cross-section on line B-B in FIG. 3A and an elevation on arrow C in FIG. 3A of a die used in the method and apparatus of the invention.

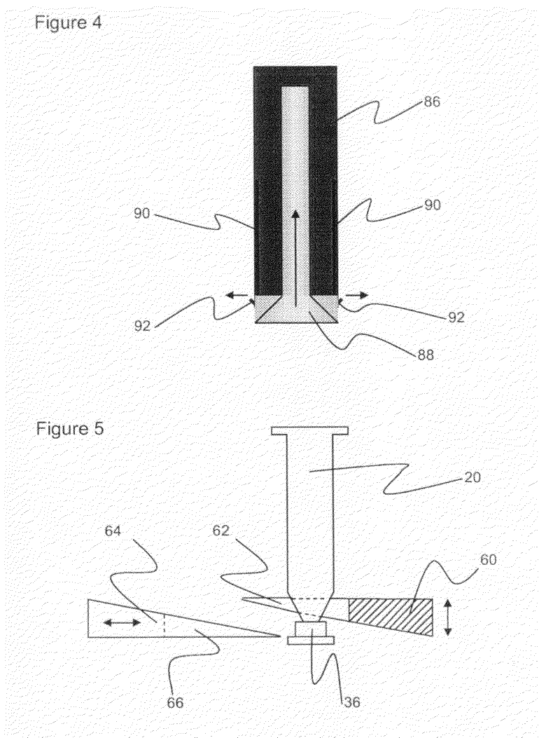

FIG. 4 is a schematic vertical section through the lower end of the piston rod 86 shown in FIG. 2;

FIG. 5 is a schematic side elevation, partly in section, of the syringe cap and die removal station 32 of FIG. 1;

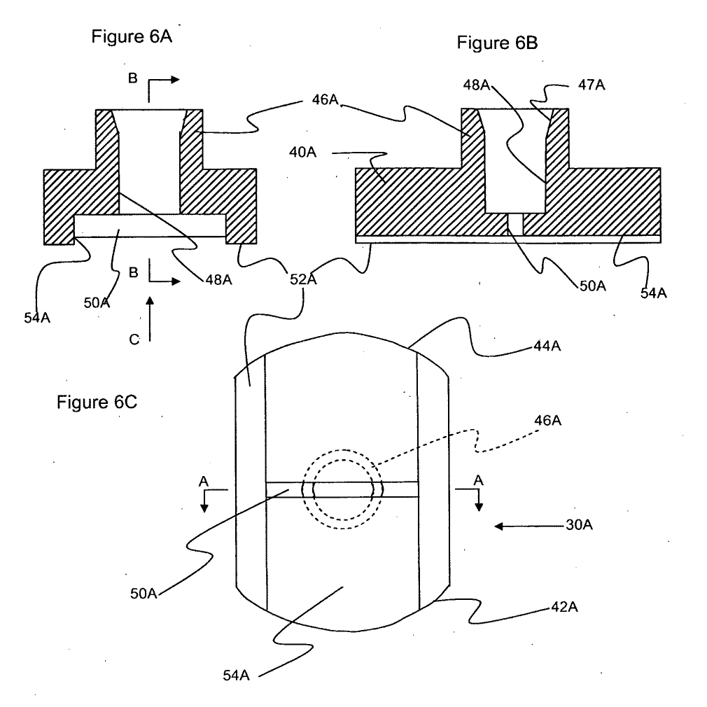

FIGS. 6A to 6C are respectively a cross-section on line A-A in FIG. 6C, a cross-section on line B-B in FIG. 6A and an elevation on arrow C in FIG. 6A of another embodiment of a die used in the method and apparatus of the invention; and

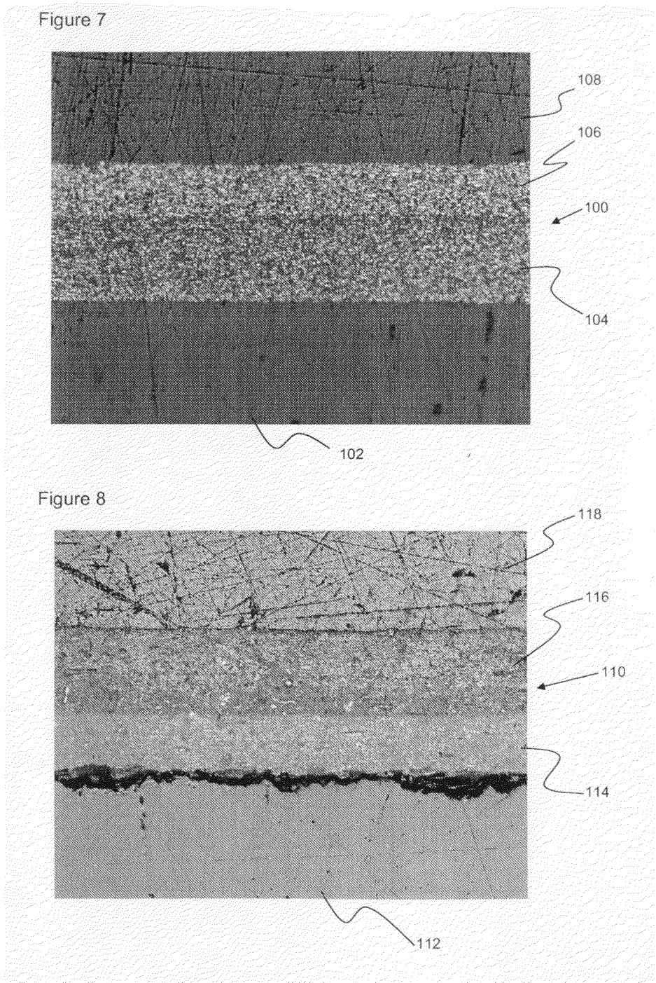

FIGS. 7 and 8 are microscope images of sectioned composite films as described in Examples 3 and 4 below.

Apparatus 10 according to the invention is shown in FIG. 1. The apparatus 10 has a frame 12 on which is mounted an automated XYZ handling system 14. Also located on the base plate 16 of the frame 12 are:
a rack 18 containing syringes 20, for example 10 ml syringes available from EFD;
two racks 22 into each of which may be securely mounted for example thirty two glass slides (not shown) on each of which a liquid film may be deposited in use of the apparatus 10, each rack having an upper plate (as shown) having elongate slots 24 corresponding to but slightly larger than a sample location position on the respective glass slide;
a rack 26 for containing dies 30 (described in more detail below);
a rack 28 for containing new syringe caps 36;
a syringe cap and die removal station 32;
a reception container (not shown), which may contain solvent or other liquid, which is located beneath an aperture in the base plate 16 for receiving removed syringe caps 36 and dies 30;
a reception container (not shown) which is located beneath an aperture in the base plate 16 for receiving syringes 20 that have been used; and
a dispensing system 34 (see FIG. 2) mounted on the handling system 14 for vertical movement (Z axis) relative to the frame 12.

Although glass slides have been exemplified as the substrates for receiving films of liquid samples, it will be appreciated from the earlier description, that other materials and other sizes of substrate may be readily used with the apparatus 10 of the invention.

The dies 30, according to the invention, (see FIGS. 3A to 3C) may be made of plastic or metal, for example brass, and each have an elongate body 40 which, in this embodiment, has rounded ends 42, 44 and, on the upper surface thereof, a centrally-located annular projection 46 coaxial with a cylindrical hole 48 in the body 40. The upper end of the annular projection 46 is countersunk at 47 to aid location of the outlet ends of syringes 20.

The cylindrical hole 48 terminates within the body 40 of the die 30 and is intersected at its inner end by a slot 50 extending transversely of the body 40.

The lower planar surface 52 of the body 40 of the die 30 has machined or moulded therein a rebate 54 which is open at and extends from one end 42 longitudinally of the body 40 towards the opposite end 44 for an amount greater than half the length of the body 40 whereby it terminates at a position past the slot 50 to provide a liquid dead space 56. The provision of such a dead space 56 is preferred as it is thought to act as a small liquid reservoir to accommodate minor pressure fluctuations and possibly to aid surface wetting. The rebate 54 will be dimensioned to produce a film of required dimensions as previously described.

The syringe cap and die removal station 32 has a first, upper wedge 60 having a U-shaped aperture 62 for receiving a lower end of a syringe 20 (shown with a cap 36) carried by the dispensing system 34, the portions of the wedge 60 forming the limbs of the aperture 62 being sufficiently close together to engage the cap 36 or die 30 to be removed. The first wedge 60 is tapered towards the open end of the aperture 62 and has a horizontally-oriented upper surface and an inclined lower surface and is mounted on a bearing (not shown) for reciprocal vertical movement as indicated by the arrow. The station 32 also has a second wedge 64, having a U-shaped aperture 66, substantially the same as the first wedge 60 but having an orientation which is inverted as compared to the orientation of the first wedge 60. The second wedge 64 is mounted on a pneumatic actuator (not shown) for reciprocal horizontal movement as indicated by the arrow relative to the XY position of the first wedge 60. Movement of the second wedge 64 towards the first wedge 60 causes the lower, horizontal surface of the second wedge 64 to engage the cap 36 (or die 30) and to move the first wedge 60, together with the dispensing system 34, vertically to separate the syringe 20 from the cap 36 (or die 30).

The dispensing system 34 is mounted on a Z axis support member 70 of the handling system 14 through a linear bearing 72. The dispensing system 34 is retained relative to the support member 70 by a compression spring 74 mounted on the support member 70 by a bracket 76.

The dispensing system 34 has a frame 78, which is U-shaped in section, mounted on the linear bearing 72. Pneumatically-operated gripper members 80 for holding a syringe 20 are mounted on the lower limb of the frame 78. An electric stepper motor 82 is mounted on the upper limb of the frame 78. The motor 82 is used to drive a lead screw 84 which is supported in threaded apertures in the limbs of the frame 78.

Mounted for vertical movement on the lead screw 84 is a hollow piston rod 86 mounted within the lower end of which is a spreader member 88 which is movable axially of the piston rod 86. Also mounted on the lower end of the piston rod 86 are two radially opposed spring steel grippers 90 having at their lower ends slight barbs 92. Axial movement upwards of the member 88 causes the lower ends of the grippers 90 to move radially outwardly and engage a piston head member (not shown) in the syringe 20 whilst reversal of that movement allows the grippers 90 to return radially inwardly owing to their inherent resilience and disengage from such a piston member.

The handling system 14 and other actuators forming part of the apparatus 10 are controlled using a computer (not shown) which is programmable with the required sequence of operation of the apparatus 10.

In operation, the dispensing system 34 is moved by the handling system 14 to rack 18 and picks up a first syringe 20. As the volumes of materials in the syringes 20 are not known, before the grippers 80 grip a syringe 20, the piston rod 86 is lowered using the motor 82 and the lead screw 84 into the syringe 20 until upward movement, owing to contact with the piston head member in the syringe 20, of the dispensing system 34 is sensed. Following sensing of such movement, movement of the piston rod 86 is stopped and the piston rod 86 is moved down by a user-determined amount to prime the die with liquid from the syringe 20. The grippers 80 are then closed to grip the syringe 20.

The dispensing system 34 is then moved to the syringe cap and die removal station 32 whereat the syringe 20 is located relative to the first wedge 60. The second wedge 64 is then moved horizontally to engage the cap 36 and the first wedge 60 to cause vertically movement of the first wedge 60 to remove the cap 36 from the syringe 20 and let it drop into the reception container. The dispensing system 34 is then moved to rack 26 to a position over a first die 30 and lowered to engage the outlet end of the syringe 20 in the annular projection 46 of the die 30. To ensure the syringe 20 and die 30 are correctly engaged, after initial contact the grippers 80 release the syringe 20 and then re-grip it whilst the dispensing system applies downward force to it.

The dispensing system 34 is then moved to a first dispensing position on the first rack 22 and is lowered to contact the planar face 52 of the die 30 with the glass slide located at that dispensing position. The die 30 is located at on end of a sample location position on the glass slide, the die 30 being orientated such that the end 44 thereof is facing the direction in which the die 30 will be moved. The die 30 contacts the glass slide with a pressure that is a combination of the weight of the dispensing system 34 and pressure applied by the spring 74. The amount of contact pressure generated is a function of the weight of the dispensing system 34, the spring constant of the spring 74 and the amount of compression applied to the spring 74. Typically, it may be in the region of around 10N to 35N.

The piston rod 86 is lowered to dispense liquid from the syringe 20 whilst at the same time the dispensing system 34, and hence the die 30 still in contact with the glass slide, is moved towards the remote end of the sample location position. Under this combined action, liquid flows into the channel defined by the planar surface 52 and the rebate 54 of the die 30 together with the glass slide and is deposited on the glass slide as the die 30 moves along it.

As the die 30 nears the end of the sample location position, movement of the piston rod 86 relative to the syringe 20 is stopped and, as it reaches the end of the sample location position, the dispensing system 34 is moved upwardly to lift the die 30 from contact with the glass slide whilst at the same time the piston rod 86 is retracted slightly relative to the syringe 20.

If the liquid sample in syringe 20 is to be used to form more than one film, the dispensing system 34 is moved to a second, and, if necessary, subsequent, glass slide on the rack 22 and the dispensation procedure is repeated. In a typical experimental set up, up to four films may be formed from each syringe 20.

Once the film or films have been formed, the dispensing system 34 is then moved to the syringe cap and die removal station 32 whereat the die 30 is removed from the syringe 20 similarly to the removal of the cap 36 therefrom as previously described.

The dispensing system 34 is then moved to rack 28 and positioned over a first cap position and is lowered to engage the end of the syringe 20 with a new cap 36. The dispensing system 34 is then moved to the location of the reception container for used syringes 20 and the syringe 20 is released to fall into the container. The used syringes 20 may be either disposed of or, if they contain liquid formulations that are still of interest, collected for re-use. If the latter, the reception container may be environmentally controlled, for example by being cooled.

The sequence is repeated for other syringes 20.

Once a rack 22 has had films formed on all of its glass slides, the computer may be paused to permit removal of that rack 22 from the frame 12, and optionally, replenishment of the syringe rack 18 and the die and cap racks 26 and 28, and insertion of a freshly loaded rack 22 into the frame 12. The glass slides may then be treated as previously described to form solid films.

In an alternative embodiment, dies 30A, according to the invention, (see FIGS. 6A to 6C) each have an elongate body 40A which, in this embodiment, has rounded ends 42A, 44A and, on the upper surface thereof, a centrally-located annular projection 46A coaxial with a cylindrical hole 48A in the body 40A. The upper end of the annular projection 46A is countersunk at 47A to aid location of the outlet ends of syringes 20.

The cylindrical hole 48A terminates within the body 40A of the die 30A and is intersected at its inner end by a slot 50A extending transversely of the body 40A.

The lower planar surface 52A of the body 40A of the die 30A has machined or moulded therein a rebate 54A which is open at and extends along the full length of the die 30A from one end 42A longitudinally of the body 40A to the opposite end 44A. The rebate 54 will be dimensioned to produce a film of required dimensions as previously described.

The invention will now be described further with reference to the following Examples.

### EXAMPLE 1

10 ml syringes 20 were prepared with paint samples, having a viscosity of about 5 Pa·s, and adhesive samples (Ablebond 8200C, a silver-filled epoxy resin adhesive available from Ablestik), having a dynamic viscosity of about 10 Pa·s. The syringes were used to generate films on glass microscope slides in accordance with the invention using dies 30 as described with reference to FIGS. 3A to 3C. The rebates in the dies 30 were 17 mm long, 10 mm wide and had depths of 75 μm and 450 μm, respectively. The slot 50 of the die 30 that opens into the rebate is 10 mm from the front end of the die 30 and is 1 mm wide. The paint films were allowed to dry at ambient temperature. The adhesive films were cured in a box oven at about 175° C.

The films were then measured using a micrometer at three positions (Positions 1, 2 and 3 in the Tables) located on the longitudinal axes of the films, Position 2 being approximately half way along the lengths of the films and Positions 1 and 3 being either side of Position 2.

The paint sample films made using a die having a depth of 75 μm were numbered 1 to 8 and the paint sample films made using a die having a depth of 450 μm were numbered 9 to 16 and the results of the measurements made are given in Table 1. The % age relative standard deviations (% RSD) of each set of measurements along the length of the film are given and the % RSD of each set of measurements at each measurement point. Similarly, the adhesive sample films were numbered 17 to 24 and 25 to 32, respectively, the results being given in Table 2.

### EXAMPLE 2

### Comparative

The liquid samples used in Example 1 were used to generate two sets of films on glass microscope slides on which channels were formed using a tape of approximately 130 μm, the first set of slides having only a single layer of tape along each side thereof and the second set of slides having three layers of tape along each side thereof. The liquid samples deposited on the slides were leveled using a doctor blade. The films were allowed to dry or were cured as described in Example 1 and the thicknesses of the films were measured as described in Example 1.

The paint sample films made using a single tape thickness, ie in a channel having a nominal depth of approximately 130 μm, were numbered 1C to 8C and the paint sample films made using a triple tape thickness, ie in a channel having a nominal depth of approximately 390 μm, were numbered 9C to 16C, the results being given in Table 3. Similarly, the adhesive sample films were numbered 17C to 24C and 25C to 32C, respectively, the results being given in Table 4.

TABLE 1

| Sample | Position 1 | Position 2 | Position 3 | % RSD |
|---|---|---|---|---|
| 1 | 26 | 28 | 29 | 5.52 |
| 2 | 33 | 32 | 33 | 1.77 |
| 3 | 29 | 31 | 31 | 3.81 |
| 4 | 34 | 32 | 27 | 11.63 |
| 5 | 30 | 32 | 33 | 4.82 |
| 6 | 32 | 34 | 34 | 3.46 |
| 7 | 30 | 28 | 25 | 9.10 |
| 8 | 31 | 33 | 31 | 3.65 |
| % RSD | 8.19 | 7.11 | 10.44 | |
| 9 | 114 | 129 | 120 | 6.24 |
| 10 | 109 | 119 | 118 | 4.78 |
| 11 | 113 | 122 | 112 | 4.76 |
| 12 | 123 | 131 | 127 | 3.15 |
| 13 | 119 | 124 | 123 | 2.17 |
| 14 | 127 | 132 | 126 | 2.50 |
| 15 | 128 | 133 | 131 | 1.93 |
| 16 | 126 | 129 | 130 | 1.62 |
| % RSD | 6.12 | 4.01 | 5.34 | |

TABLE 2

| Sample | Position 1 | Position 2 | Position 3 | % RSD |
|---|---|---|---|---|
| 17 | 45 | 46 | 50 | 5.63 |
| 18 | 51 | 44 | 44 | 8.72 |
| 19 | 49 | 49 | 49 | 0.00 |
| 20 | 48 | 42 | 41 | 8.67 |
| 21 | 46 | 46 | 40 | 7.87 |
| 22 | 48 | 48 | 48 | 0.00 |
| 23 | 45 | 45 | 44 | 1.29 |
| 24 | 48 | 43 | 43 | 6.46 |
| % RSD | 4.36 | 5.26 | 8.29 | |
| 25 | 189 | 176 | 187 | 3.80 |
| 26 | 187 | 178 | 182 | 2.47 |
| 27 | 185 | 176 | 177 | 2.75 |
| 28 | 182 | 176 | 184 | 2.30 |
| 29 | 184 | 179 | 182 | 1.39 |
| 30 | 176 | 177 | 169 | 2.51 |
| 31 | 186 | 176 | 186 | 3.16 |
| 32 | 176 | 177 | 173 | 1.19 |
| % RSD | 2.65 | 0.64 | 3.56 | |

TABLE 3

| Sample | Position 1 | Position 2 | Position 3 | % RSD |
|---|---|---|---|---|
| 1C | 56 | 57 | 65 | 8.31 |
| 2C | 47 | 43 | 40 | 8.10 |
| 3C | 39 | 42 | 40 | 3.79 |
| 4C | 48 | 55 | 55 | 7.67 |
| 5C | 59 | 57 | 54 | 4.44 |
| 6C | 50 | 50 | 59 | 9.80 |
| 7C | 61 | 55 | 57 | 5.30 |
| 8C | 82 | 69 | 81 | 9.35 |
| % RSD | 26.42 | 17.79 | 26.09 | |
| 9C | 134 | 136 | 140 | 2.24 |
| 10C | 130 | 129 | 127 | 1.19 |
| 11C | 126 | 129 | 114 | 6.45 |
| 12C | 141 | 140 | 134 | 2.74 |
| 13C | 138 | 142 | 136 | 2.20 |
| 14C | 137 | 123 | 140 | 6.81 |
| 15C | 129 | 125 | 114 | 6.33 |
| 16C | 137 | 134 | 133 | 1.55 |
| % RSD | 3.89 | 5.22 | 8.18 | |

TABLE 4

| Sample | Position 1 | Position 2 | Position 3 | % RSD |
|---|---|---|---|---|
| 17C | 62 | 61 | 57 | 4.41 |
| 18C | 67 | 69 | 69 | 1.69 |
| 19C | 65 | 69 | 70 | 3.89 |
| 20C | 67 | 67 | 70 | 2.55 |
| 21C | 60 | 58 | 61 | 2.56 |
| 22C | 56 | 61 | 60 | 4.48 |
| 23C | 56 | 59 | 61 | 4.29 |
| 24C | 59 | 60 | 63 | 3.43 |
| % RSD | 7.32 | 7.25 | 7.96 | |
| 25C | 166 | 166 | 171 | 1.72 |
| 26C | 168 | 167 | 174 | 2.23 |
| 27C | 169 | 173 | 167 | 1.80 |
| 28C | 175 | 167 | 173 | 2.43 |
| 29C | 182 | 175 | 184 | 2.62 |
| 30C | 172 | 171 | 174 | 0.89 |
| 31C | 163 | 164 | 168 | 1.60 |
| 32C | 179 | 178 | 181 | 0.85 |
| % RSD | 3.81 | 2.89 | 3.39 | |

As can be seen from a comparison of the % RSD figures for each film and the % RSD figures for each measurement point on the films, films formed in accordance with the invention are at least comparable with films formed using the known technique. Additionally, the repeatability of film formation (% RSD figures of measurement points), especially for thinner films and for lower viscosity materials, is enhanced in films made in accordance with the method of the invention as compared to the films made using the known technique.

### EXAMPLE 3

An adhesive multilayer composite film 100 on a glass slide 102 was prepared using the method of the invention. A first film layer 104 of a first conductive adhesive was deposited onto the glass slide 102 using a die 30A as described with reference to FIGS. 6A to 6C, the die 30A having a rebate 20 mm long (measured at the apices of the rounded ends 42A, 44A thereof), 10 mm wide and a depth of 220 μm. The first film layer 104 was then oven cured.

A second film layer 106 of a second, different conductive adhesive, was deposited on top of the first film layer 104 using a second die 30A as described with reference to FIGS. 6A to 6C, the die 30A having a rebate 20 mm long (measured at the apices of the rounded ends 42A, 44A thereof), 10 mm wide and a depth of 500 μm. The second film layer 106 was then oven cured.

To enable the composite film 100 to be examined, the composite film 100 on the glass slide 102 was encapsulated in epoxy resin 108 which was then cured and the encapsulated composite film 100 and glass slide 102 was sectioned and polished. A microscope image of the cross-section of the multilayer composite film 100 is shown in FIG. 7. The interface between the two film layers 104, 106 of the adhesives may be clearly seen in the image. The thickness of the first film layer 104 was about 145 μm and of the second film layer 106 about 85 μm. Overall, the thickness of the multilayer composite film 100 was about 230 μm. The profile of the composite film 100 was studied using a laser profilometer, the three dimensional image from which showed the thickness of the composite film 100 was very uniform along its length and width and was consistent with the thickness obtained from microscope image.

### EXAMPLE 4

To demonstrate a paint multilayer composite film 110, a first film layer 114 of a water-based emulsion paint, was deposited onto a glass slide 112 using a die 30A as described with reference to FIGS. 6A to 6C, the die 30A having a rebate 20 mm long (measured at the apices of the rounded ends 42A, 44A thereof), 10 mm wide and a depth of 220 μm. The first film layer 114 was then allowed to dry in ambient conditions.

A second film layer 116 of a water-based paint, but being of a different colour, was deposited on top of the first film layer 114 using a second die 30A as described with reference to FIGS. 6A to 6C, the die 30A having a rebate 20 mm long (measured at the apices of the rounded ends 42A, 44A thereof), 10 mm wide and a depth of 500 μm. The second film layer 116 was then allowed to dry in ambient conditions.

To enable the composite film 110 to be examined, the composite film 110 on the glass slide 112 was encapsulated in epoxy resin 118 which was then cured and the encapsulated composite film 110 and glass slide 112 was sectioned and polished. A microscope image of the cross-section of the multilayer composite film 110 is shown in FIG. 8. The interface between the two film layers 114,116 of the paints may be clearly seen in the image. The thickness of the first film layer 114 was about 47 μm and of the second film layer 116 about 74 μm. Overall, the thickness of the multilayer composite film 110 was about 121 μm. The profile of the composite film 110 was studied using a laser profilometer, the three dimensional image from which showed the thickness of the composite film 110 was very uniform along its length and width and was consistent with the thickness obtained from microscope image.

As will be appreciated, the use of paints of different colours in this example was merely for convenience to demonstrate the formation of a multilayer composite film and that other paint systems, for example using pigmented and unpigmented coatings such as primer-, under- and top-coat paints, may be studied using the methods and apparatus of the invention.

1. A method of forming a film on a surface of a substrate comprises providing a reservoir containing a liquid sample to be formed into a film at a sample location position on the substrate surface, said reservoir having an outlet comprising a die having a planar face which is contactable with said substrate to define therewith a channel for receiving at least a portion of said liquid sample from said reservoir, contacting said die with said substrate at one end of said sample location position, causing said liquid sample to extrude through said die and into said channel whilst substantially simultaneously moving said die and said substrate in contact with and relative to one another whereby said die moves towards a remote end of said sample location position to deposit a film of said liquid sample at said sample location position.

2. A method according to claim 1 wherein said reservoir is a cartridge.

3. A method according to claim 1 comprising engaging said reservoir with said die by causing relative movement between the two to create a push fit therebetween.

4. A method according to claim 1 comprising applying pressure to said liquid sample in said reservoir to cause said liquid sample to flow through said die.

5. A method according to claim 1 comprising applying pressure to said liquid sample in said reservoir to cause said liquid sample to flow sufficiently to fill a prime volume in said die.

6. A method according claim 1 comprising forming said channel by providing in the planar face of said die a rebate into which said liquid sample flows.

7. A method according to claim 6 wherein said rebate extends longitudinally completely across the planar face of said die to opposed ends of said die to form openings thereat.

8. A method according to claim 6 wherein said rebate extends only partially longitudinally across the planar face of said die at least from an entry point of said liquid sample into said rebate to one end of said die to form an opening thereat.

9. A method according claim 1 wherein said liquid sample has a dynamic viscosity in the range of about 0.05 Pa·s up to about 100 Pa·s.

10. A method according to claim 1 wherein said film comprises a composite film having at least two film layers, said composite film being formed by depositing a first film layer on said surface and then depositing a second film layer onto the first film layer and, if desired, subsequent film layers in sequence on the second film layer and subsequent film layers.

11. A method according to claim 1 wherein at least two liquid samples are dispensed at sample location positions on said surface.

12. A method according to claim 1 wherein an array of films is formed on a single substrate.

13. A method according to claim 1 wherein each film in an array of films is formed on a single substrate.

14. A method according to claim 1 comprising disposing of said die following formation of at least one film therewith.

15. A method of forming a plurality of films at respective sample location positions on a surface of a substrate comprises:
(a) providing a plurality of liquid samples in respective syringes, which syringes being closed at their outlet ends by respective caps;
(b) either in parallel or sequentially removing the cap from each syringe and fitting a die to the outlet end of the syringe, each said die being contactable with said substrate to define therewith a respective channel for receiving at least a portion of a liquid sample;
(c) either in parallel or sequentially contacting said respective die with said substrate at one end of a respective said sample location position;
(d) either in parallel or sequentially causing the liquid sample in each respective syringe to extrude through said respective die and into said respective channel whilst simultaneously moving said die and said substrate in contact with and relative to one another whereby said die moves towards a remote end of said sample location position to deposit a film of said liquid sample at said sample location position.

16. Apparatus for forming a film on a surface of a substrate comprises a substrate support means and a dispensing system for dispensing at least one liquid sample at a sample location position on a surface of a substrate supported by said substrate support means during operation of said apparatus, said dispensing system comprising gripper means for holding a reservoir which, in use, contains a liquid sample, said reservoir having an outlet comprising a die having a planar face which is contactable with said substrate to define therewith a channel for receiving at least a portion of said liquid sample from said reservoir, said dispensing system being operable to contact said die with said substrate at one end of said sample location position whilst substantially simultaneously being operable to move said die and said substrate in contact with and relative to one another whereby said die moves towards a remote end of said sample location position to deposit a film of said liquid sample at said sample location position.

17. Apparatus according to claim 16 wherein said die has in the planar face thereof a rebate.

18. Apparatus according to claim 17 wherein said rebate extends longitudinally completely across the planar face of said die to opposed ends of said die to form openings thereat.

19. Apparatus according to claim 17 wherein said rebate extends only partially longitudinally across the planar face of said die at least from an entry point of said liquid sample into said rebate to one end of said die to form an opening thereat.

20. Apparatus according to claim 16 wherein said dispensing system comprises means to apply pressure to a liquid sample in said reservoir.

21. Apparatus according to claim 16 wherein the dispensing system comprises a piston rod engageable with a piston in said reservoir whereby said piston is movable to effect positive displacement or drawback of said liquid sample in said reservoir.

22. Apparatus according to claim 21 wherein said piston rod is movable relative to said gripper means by a lead screw driven by a stepper motor, which is connected to said piston rod.

23. Apparatus according to claim 21 wherein said piston rod is engageable with said piston by second gripper means.

24. Apparatus according to claim 23 wherein said second gripper means comprises at least one spring steel grippers movable between an inactive position and an active position in which the or each gripper engages said piston.

25. Apparatus according to claim 16 comprising automated handling equipment for indexing said substrate support and said dispensing system relative to one another whereby, in use, at least two films may be deposited on a substrate surface at sample location positions on said surface that are in space relationship from one another.

26. A die comprising a body having a planar face in which a rebate for receiving liquid is formed and a liquid flow passage extending through the body and terminating in said rebate.

27. A die according to claim 26 wherein said rebate extends longitudinally completely across the planar face of said die to opposed ends of said die to form openings thereat.

28. A die according to claim 26 in which the rebate extends partially longitudinally across said planar face of the die at least from said passage to one end of the die to form an opening thereat whereby said end of the die is a trailing end relative to a direction of motion of the die in use.

29. A die according to claim 26 in which the rebate extends longitudinally beyond said passage towards a leading end of said die relative to a direction of motion of the die in use.

30. A die according to claim 26 wherein said passage terminates in a slot that extends substantially the whole width of said rebate.

31. At least one array of films, wherein each film is uniformly located with reference to a sample location position in the array.

32. A library of films comprising at least two arrays of films, each on a substrate, wherein each film is uniformly located with reference to a sample location position in the array.
